(19) United States
(12) Patent Application Publication
(10) Pub. No.: US 2004/0079201 A1
(43) Pub. Date: Apr. 29, 2004

(54) Portable fiber preparation system

(76) Inventor: Robert G. Wiley, Frankfort, KY (US)

Correspondence Address: David M. Mello, McDermott, Will & Emery, 28 State Street, Boston, MA, 02109, US

(21) Appl. No.: 10/617,907

(22) Filed: Jul. 11, 2003

Related U.S. Application Data
(60) Provisional application No. 60/395,300, filed on Jul. 12, 2002.

(51) Int. Cl. H02G 1/12

(52) U.S. Cl. 81/9.4

(57) ABSTRACT

A handheld stripper includes a handheld housing having a chamber configured to hold a volume of pressurized combustible gas. Combustion of the gas occurs at an output nozzle. A filter is disposed between the output nozzle and fiber and is configured to radiate heat in the direction of the fiber, while preventing a combustion flame from contacting the fiber.

### CROSS REFERENCE TO RELATED APPLICATIONS

This application claims the benefit of priority under 35 U.S.C. §119(e) from co-pending, commonly owned U.S. provisional patent application serial No. 60/395,300, entitled Method For The Removal Of fiber Coatings For Use In The Field, filed Jul. 12, 2002.

### FIELD OF THE INVENTION

The inventive concepts relate to portable or handheld units for stripping coatings from fibers, wires, or the like, such as fiber optic coatings.

### BACKGROUND

Fiber optic cables are widely used in modem optical devices and optical communications systems. Optical fibers are usually coated with a protective layer, for example a polymer coating, in order to protect the surface of the fiber from chemical or mechanical damage. When extra protection is required a fiber with an additional layer of coating is used. This additional layer is typically made up of nylon, PVC, or Hytrel. This additional layer extends the outer diameter out to 900 microns from the typical 250 microns. This additional layer is sometimes bonded to the acrylate 250 micron layer. It is necessary to remove the protective coatings in order to prepare the fibers to be cleaved and spliced, or in order to further process the fibers to manufacture optical devices such as optical sensors and other optical communications network components.

Conventional stripping methods include mechanical stripping, chemical stripping, and thermal stripping. These methods all suffer from a number of defects. Mechanical stripping typically involves a stripping tool, similar to a wire stripper, which cuts through the coating and scrapes it off. A major disadvantage is that mechanical stripping typically nicks or scratches the glass fiber surface, eventually leading to cracks and to degradation in the tensile strength of the fiber. By way of example, the tensile strength of an optical fiber may be reduced from about 15-16 pounds before mechanical stripping to about 3-5 pounds after mechanical stripping. The optical fiber's longevity is thereby reduced.

Chemical stripping uses solvents or concentrated acids to remove the polymer coating. In the prior art, acid stripping is often performed using a sulfuric nitric mixture that includes about 95% sulfuric acid and about 5% nitric acid. While this prior art method reduces tensile strength degradation, an acid residue may typically be left on the fiber surface at the splice point. Therefore, using chemical stripping on titanium dioxide color coded fiber degrades the splice strength. Also, chemical stripping as performed in the prior art is very costly.

Additionally, there are major safety concerns inherent in chemical stripping methods. Ventilation and safety equipment may be needed when using acids for the stripping process. Human operators performing acid stripping require facilities having well-ventilated areas, preferably with exhaust or ventilation hoods for removing acid fumes. They may also require protective gear, such as protective clothing and gloves for avoiding acid bums, and protective breathing apparatus for protection from acid fumes in the air. Storing, handling, and transporting the acids are also extremely hazardous.

This chemical stripping process cannot be effectively used on the 900 micron layer of a fiber due to it's make up. If one were to attempt to use acid to remove the 900 layer as well as the 250 layer the acid would wick up between the 900 layer and the 250 layer in the area adjacent to the area of desired stripping creating a longevity problem. This approach would also cause severe contamination of the acid medium reducing its usability and potentially causing recontamination of the fiber.

With any of the foregoing approaches, the stripping of optical fibers is traditionally done at a location having installed stripping equipment or stations. As previously mentioned, in addition to the stripping apparatus, there may be a variety of ancillary systems or devices required to perform the stripping safely. Such installed stripping systems do not lend themselves to field operations. However, it would be advantageous for those in the field to have the capability to perform stripping operations as part of maintenance, repair or installation of optical fibers.

### SUMMARY OF THE INVENTION

A portable or handheld fiber stripper, useful in the field, includes a small combustible gas source (e.g., butane propane or a mix thereof) may be coupled to a handle or within a housing. The housing may include an actuator configured to simultaneously release the gas from a nozzle, while also causing a spark in close proximity to the nozzle. Consequently, the spark ignites the burst of butane gas upon actuation of the actuator. The filter (e.g., a mesh screen) is preferably secured at a fixed distance from the nozzle, such that it is disposed between the nozzle and a fiber to be stripped. The orientation of the mesh is preferably about perpendicular to the general direction of the burst. Heat is radiated from the filter and in the direction of the fiber. The heat delivered to the fiber is sufficiently how to remove the coating or coatings from a fiber or fiber ribbon.

A cleaver may be included to allow cleaving of the stripped fiber. A translator may be provided to move the fiber with respect to the filter, or vice versa. The translation could be in one direction along the length of the fiber, for example, or both directions with respect to the length of the fiber. A supplemental gas supply (e.g., air or inert gas) could be provided to assist in directing and/or propelling the heat toward the fiber. To strip a multi-coating fiber, multiple bursts can be used, e.g., one for each coating.

### BRIEF DESCRIPTION OF THE DRAWINGS

The drawing figures depict preferred embodiments by way of example, not by way of limitations. In the figures, like reference numerals refer to the same or similar elements.

FIG. 1A is a view of a handheld optical fiber stripper in accordance of the present invention and FIG. 1B is a view of the filter and output nozzle orientation of the stripper of FIG. 1A.

FIG. 2 is a view of alternate output nozzles that may be used with the stripper of FIG.1.

FIG. 3-FIG. 5 are views of the stripper of FIG. 1 with various bridges.

FIG. 6 is a view of the stripper of FIG. 1 with an air bladder.

FIG. 7 is a vie of the stripper of FIG. 1 with a cleaver.

FIG. 8 is a view of an optional filter arrangement, that could be used with the stripper of FIGS. 1-7.

### DETAILED DESCRIPTION OF THE PREFERRED EMBODIMENTS

The present invention provides a portable system and method for heat stripping an optical fiber, or other material having a polymer coating (collectively referred to as “fiber”). An ignited burst of combustible gas (e.g., butane or propane) is injected from a source, and applied along the stripping length of the optical fiber or to a portion thereof. The fiber may be a single fiber or may be a ribbon of fiber. The fiber is not directly exposed to the flame; instead the flame heats a fine wire mesh that is in close proximity to the fiber. The heat is then transferred to the fiber via radiation. The flow that is required in the process comes from the expansion of air around the wire mesh as well as from energy from the release and combustion of the gas in the direction of the fiber. That is, often the combustible gas is contained under pressure, so when released the gas may be directed toward the fiber to assist in directing heat toward the fiber. This flow can also be supplemented by injecting additional air or inert gas through the wire mesh towards the fiber.

The burst of heated gas directed at the fiber causes the layer(s) coating the fiber to separate from the fiber and be carried away in the stream of heated gas (e.g., air or inert gas). Typically, the requisite temperature to remove the coating in this manner is from about 700 degrees Celsius to about 1100 degrees Celsius. The coatings of the optical fiber are removed without significantly degrading the original tensile strength of the fiber. No coating residue remains on the fiber, and no curling of the coating occurs. While heated air is used in a preferred embodiment of the invention, other embodiments may use other substances, such as other gases (e.g., inert gases) and fluids.

In some embodiments, wherein extended lengths of fiber are to be stripped, the heater may be translated in a specific motion across the length of fiber to be stripped. In other embodiments, the fiber may be translated across the volume of heated air. Where a fiber has multiple coatings, multiple bursts of heat can be used to strip the multiple coatings.

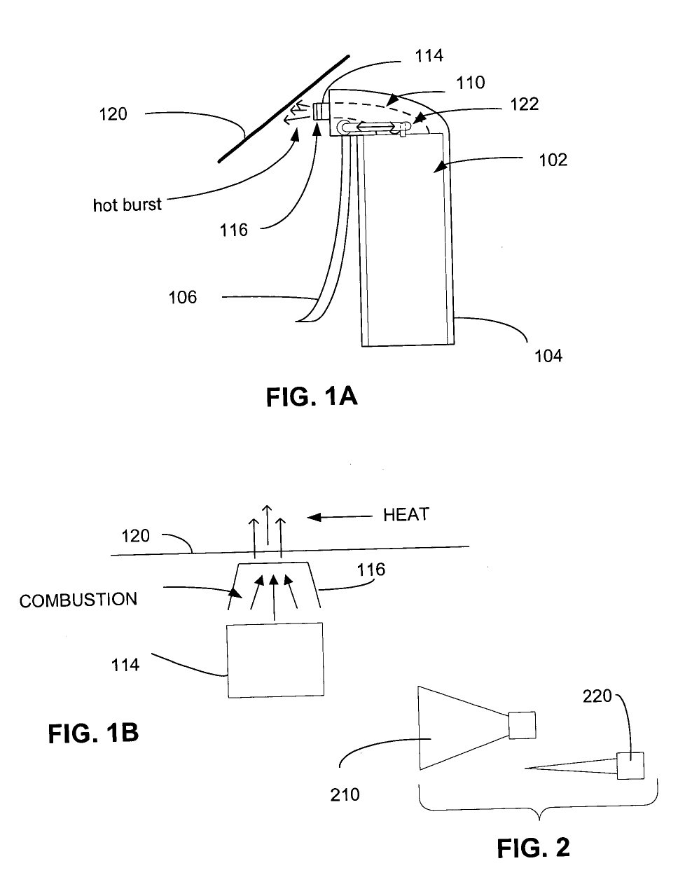

FIG. 1A shows an embodiment of a system 100 for stripping an optical fiber 120 in accordance with the present invention. The stripper 100 includes a source or chamber of combustible gas 102, such as a pressurized canister or cartridge of butane, as is known in the art. The gas chamber 102 may be located within or couple to a handheld housing 104, which may be made of molded plastic for example. An actuator 106 may be included to release the gas from the gas chamber 102. The gas chamber 102 includes a gas valve 122 which may be operatively coupled to the actuator 106. As an example, the gas valve 122 may be integral with propane/butane canister, as is known in the art. In this embodiment, the actuator is a handle 106 which causes gas to be released by manipulating gas valve 122.

Housing 104 may include a head 108 within which defines a gas flow path 110. The gas flow path 110 receives gas released from the gas valve 122 and directs it to an output nozzle 114. Actuator 106 may also be configured to generate a spark at output nozzle 114 to cause combustion of the released gas. In such a case, actuation of actuator 106 simultaneously causes gas to be released into gas flow path 110 and the spark to generated, thereby causing combustion at the output nozzle 114. A quick release of actuator 106 causes a burst of combustion, while maintaining actuation such that the gas flows steadily causes a steady combustion, which may be used for stripping a length of fiber.

As is shown in FIG. 2 the output nozzle may be configured in any of a variety of shapes, including, but not limited to, a fan shape 210 or a conical nozzle shape 220. For example, the fan shaped output nozzle 210 may be configured for stripping a segment of a fiber ribbon cable by orienting it orthogonal to the direction of the fibers. Or, fan shaped nozzle 210 may strip a relatively wide portion of a single fiber by orienting it parallel to the direction of the fiber. These are just example. Other shapes and orientations of output nozzles to fibers could also be used. While, the conical output nozzle 220 can be used for more precise stripping. In FIG. 1A and FIG. 1B, a tubular output nozzle 114 is shown.

Regardless of the form of the output nozzle, a filter 116 is disposed between the output nozzle 114 and the fiber 120. The orientation of the filter 116, output nozzle 114 and fiber 120 may be better appreciated by review of FIG. 1B. Characteristics of the filter are that it is capable of withstanding the temperatures generated by the combustion and prevents the combustion flame from contacting the fiber. In one embodiment, filter 116 may take the form of a fine wire mesh that acts as a heat transfer mechanism. The wire mesh may be made of metal strands capable of withstanding the temperatures generated by the combustion. In another embodiment, filter 116 may be ceramic and, for example, have a honeycomb structure. Those in the art will appreciate that there are a variety of types of material and composites, and configurations thereof, that may be useful as a filter within the context of the present invention.

Output nozzle 114 directs the combustion toward filter 116. The filter heats up in the process and radiates heat toward the fiber, preferably without the flame from the combustion actually hitting the fiber. The filter may also be useful in preventing or mitigating the transfer of combustion particles, if any, to the fiber. If the gas is under pressure, release of the pressurized gas from chamber 102 may provide sufficient energy to propel the heat toward the fiber, via the output nozzle 114 and filter 116.

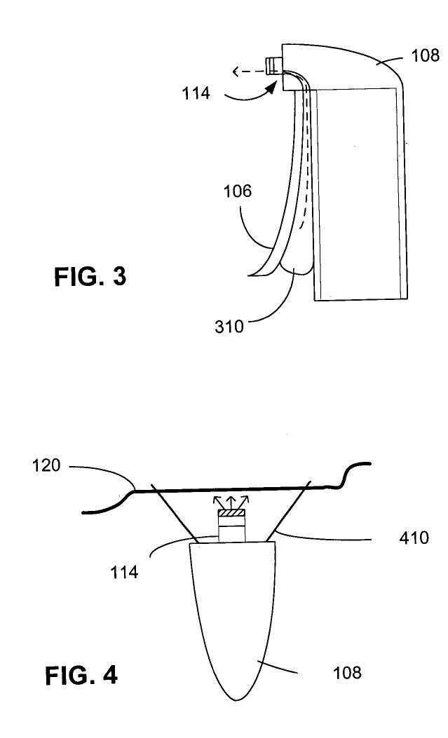

In one embodiment, a source of air (or inert gas) may be provided to assist in directing heat toward the fiber 120, wherein with each actuation a burst of air is pumped toward the filter. FIG. 3 shows and an embodiment where an air bladder 310 is provided such that actuation of actuator 106 causes simultaneous squeezing of bladder 310, which in turn causes air (or inert gas) through head 108 and to nozzle 114 to support the direction of heat toward fiber 120. It may be necessary to keep the air stream independent of the pre-combustion gas, if the introduction of air would adversely affect the combustion. In other embodiments an pump could be used. In other embodiments, the actuator could be operatively coupled to the means for generating air streams described below, to provide an air burst or stream. The same approaches could be used to introduce bursts or streams of an inert gas.

As an example, the means for generating air streams or bursts could include an air pressure generator for creating air pressure, an air pressure controller for controlling air pressure, and an air flow regulator for regulating the flow of air out of the air source so as to controllably release compressed air from the air source. In one form of the invention, the air flow regulator may be a solenoid valve controlled by a timer circuit. This same approach could be used to introduce inert gas instead of or in combination with the air.

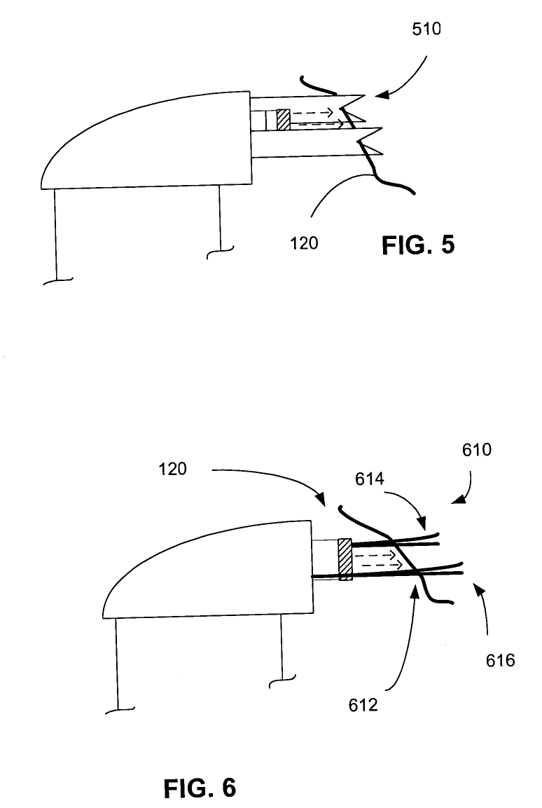

As is shown in FIG. 4, FIG. 5 and FIG. 6, in some embodiments, a fiber support may be included to support the fiber to be stripped at a relatively fixed distance from the filter 116. In FIG. 4, a bridge 410 is included to maintain the fiber 120 a fixed distance from the filter 116. The bridge 410 may take the form of a V-channel bridge 510 in FIG. 5. The V-channel shape helps ensure that fiber 120 will be oriented at a certain distance from the filter 116, and that it will also be centered with the thrust from filter 116 via the heated burst leaving output nozzle 114.

FIG. 6 shows yet another embodiment of a bridge. Here bridge 610 is configured to allow a fiber to be wedged into the bridge, up to a predetermined fixed distance from the filter 116. The fixed distance is achieved by providing a stop point 612 in each arm of the bridge, i.e., arm 614 and arm 616. Wedging the fiber 120 into the bridge 610 keeps fiber 120 taught and grips it, which can provide more consistent stripping results. Additionally, it provides an opportunity for the fiber 120 to be easily cleaved after stripping.

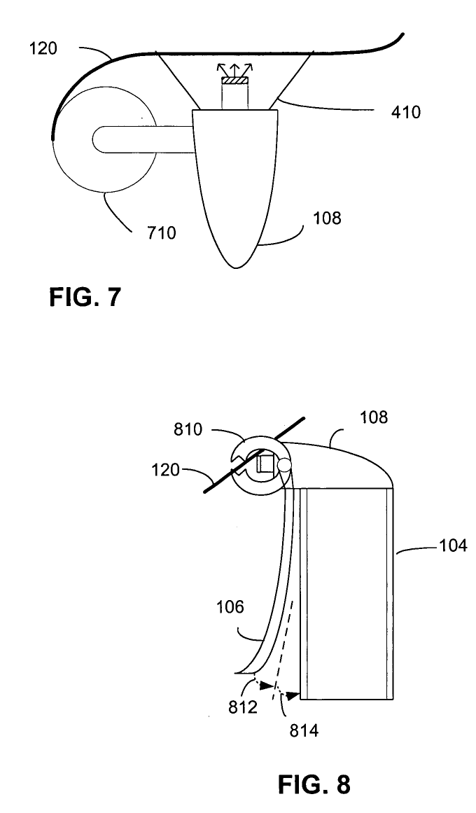

FIG. 7 shows yet other embodiment that includes the bridge 410 and a fiber translator 710. The fiber translator 710 may be such that with each actuation of the actuator, the fiber 120 to be stripped is fed past the nozzle by a relatively fixed amount. In this case, translator 710 takes the form of a wheel or spool which pulls fiber 120 past the filter 116 and output nozzle 114. As an example, assume that typically the orientation of the handheld elements strip a 1 cm portion of the fiber, the translator would be configured to translate the fiber not more about 1 cm with each actuation. To accommodate different types of fibers, the translator may be adjustable such that the amount the fiber is fed can be varied. For instance, in FIG. 7, the fiber translator 710 takes the form of a wheel controlled by the actuator 106 to move a fraction of rotation-with each actuation.

As is shown in FIG. 8, another embodiment may include a cleaver 810 that could be controlled by a second actuator (not shown). The cleaver 810 may include two arms, at least one of which includes a blade configured to cut the fiber at about the center of the stripped portion. In this embodiment, the cleaver 810 is V-shaper so as to dispose the fiber into a cleaving position as the cleaver closes. In various embodiments, actuator 106 may also control cleaver 810. In such a case, as an example, a first half squeeze 812 of actuator causes the fiber 120 to be stripped and the second (optional) half squeeze 814 cleaves the stripped fiber.

In a portable system that is larger than a handheld system, various elements of the handheld need not be of sufficiently small size or weight to facilitate integration into a handheld unit.

In other embodiments, the present invention may include any of a variety of mechanical strippers with a cleaver in a handheld or portable unit. Such a stripper may also include a bladder or other means for creating a burst of a fluid or gas (e.g., air of inert gas) useful in cleaning residue left over from the stripper from the fiber.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

What is claimed is:

1. A fiber stripper system, comprising:
A. a handheld housing having a chamber configured to hold a volume of pressurized combustible gas, wherein the gas is releasable from the chamber via a gas release valve;
B. a gas path having a first end configured to receive released gas from the gas valve and a second end configured to couple to an output nozzle configured to direct energy toward at least one fiber;
C. an igniter configured to combust the released gas at said output nozzle; and
D. a filter disposed between the output nozzle and the at least one fiber and configured to radiate heat in the direction of the fiber, while preventing a combustion flame from contacting the at least one fiber.

2. The system of claim 1, further comprising:
E. a bridge coupled to the housing and configured to maintain the at least one fiber at a fixed distance from the filter.

3. The system of claim 1, further comprising:
E. an actuator operatively coupled to the gas valve and the igniter.

4. The system of claim 1, wherein the gas comprises butane, propane, or some combination thereof.

5. The system of claim 1, wherein the filter is a metal wire mesh.

6. The system of claim 1, further comprising:
E. a cleaver configured to cut the fiber.

7. The system of claim 1, further comprising:
E. an air source configured to generate an air burst in the direction of the fiber to the filter.

8. The system of claim 1, wherein the heat is at least about 700 degrees Celsius.

9. A fiber stripper system, comprising:
A. a handheld mechanical stripper configured to strip a fiber;
B. a cleaver, coupled to the mechanical stripper; and
C. at least one actuator operatively coupled to the mechanical stripper and to the cleaver.

10. The system of claim 9, further comprising:
D. a fluid pump configured to direct a burst of fluid to the fiber.
